(19) United States
(12) Patent Application Publication
(10) Pub. No.: US 2006/0213116 A1
(43) Pub. Date: Sep. 28, 2006

(54) Treble hook lock

(76) Inventor: Dennis Cotterill, Markesan, WI (US)

Correspondence Address: NATIONAL IP RIGHTS CENTER, LLC;SCOTT J. FIELDS, ESQ., 550 TOWNSHIP LINE ROAD, SUITE 400, BLUE BELL, PA, 19422, US

(21) Appl. No.: 11/167,911

(22) Filed: Jun. 27, 2005

Related U.S. Application Data
(60) Provisional application No. 60/583,306, filed on Jun. 25, 2004.

(51) Int. Cl. A01K 97/06

(52) U.S. Cl. 43/57.2; 43/17; 43/57.1

(57) ABSTRACT

A mechanism for supporting a treble hook on a tip up. The invention comprises a base member for affixing the mechanism to a tip-up supporting a rod and reel; at least two u-shaped side supports affixed to opposite ends of the base member, said side supports having axially aligned holes to hold and support two rod members; support member and having two apertures for aligning with and sliding on the rods and having recessed walls configured to secure and support a treble hook in a locked position; spring means affixed to the rods for biasing the support member in a first position such that when the reel and line is locked, the treble hook is locked and secured.

### CROSS REFERENCE TO RELATED APPLICATIONS

This application claims benefit to provisional application 60/583,306, filed on Jun. 25, 2004, entitled “Treble Hook Lock,” which is incorporated by reference herein in its entirety.

### FIELD OF THE INVENTION

The present invention is a treble lock to be used on an ice fishing tip-up to hold the treble hook securely in place while the rod and reel is moved or adjusted.

### BACKGROUND OF THE INVENTION

Ice fishing is a very popular sport throughout the world. Ice fishing is often performed with the aid of a tip-up device. Tip-up devices comprise a base member secure a rod and reel on ice and maintain the rod and reel in an upward position. An ice fisherman will typically place a number of rods around an iced area supported by tip ups. Ice fishing is often accomplished with sharp three pronged treble hooks. Many tip ups come with a pop up flag which alerts the user when a fish is on the line. Because tip ups are frequently moved and repositioned, there is a need to easily and safely store the sharp treble hook while in transit or storage.

A number of U.S Patents have issued related to the safe of fishing hooks of various types. U.S. Pat. No. 6,014,831 to Curry discloses a safe hook protector having a hard plastic hook cover capable of engaging, receiving and enveloping the barbed end of a fishing hook. The safe hook protector having a generally J-shaped body having an elongated shank receiving portion and an enclosed hook cleat cover disposed at an end thereof. The safe hook protector is capable of attachment to a fishing rod or a fishing reel where fishermen commonly attach fishing hooks while transporting a fishing pole to a fishing location. The safe hook protector is designed to prevent injuries to people and damage to property by engaging the barbed end of a fishing hook.

U.S. Pat. No. 5,335,444 to Janeiro discloses a protector for a treble hook while in storage which comprises a plastic box completely enclosing each point of the hook. The protector is designed to provide for easy insertion of the hook and to resist accidental exposure of the hook.

U.S. Pat. No. 4,667,433 discloses a fish hook safety device to safely and securely hold a hook whether single or gang while the hook is attached to a fishing line or stored in a tackle box for later attachment and use. The device has a sloping interior surface defined by the frustum of a right cone. The barbed and pointed ends of a hook rest on the sloping surface. The device accommodates a variety of hooks of different sizes and shapes.

U.S. Patent Application No. 20030051389 to Parrish discloses a weedless fishing lure of hard bodied design of multiple embodiments, which is adapted to be connected to a fishing line, the one single hook of which is connected to the lure body by a through shaft and rotates about the shaft, said body containing a cavity large enough to completely house the hooking point of the hook while it is being fished, and having a mechanism to keep the hook hidden until deployment is desired, said hook being deployable to the hooking position by back pressure against the attached fishing line and said hook remaining deployed by back pressure against the attached line.

U.S. Patent Application No. 20020189152 to Barnett discloses a storage device for fishing lures comprising a rigid spool, having a hollow interior, and a hollow lure storage element extending across the hollow interior is described. The spool has an outer surface defining an annular channel comprising a floor and two side walls extending from said floor for receiving a leader line of a fishing lure. Each of the ends of the storage element intersect with the floor of the channel to define openings in the floor of the channel. In one embodiment, at least a portion of at least one of the openings is curved to reduce the possibility for “kinking” the leader line. At least one of said walls contains a plurality of slots that will receive the end of the leader line as will also be explained below. A small aperture located on the floor adjacent to at least one of the openings receives the lead hook of a fishing lure. A tab having a hole extends from the periphery of one of said walls to permit hanging of the device.

U.S. Patent Application No. 20020073608 to Broberg discloses a tackle holder for releasably holding tackle items such as hooks, pliers, files, and other related tools. The holder has an elongated housing which holds a hook holder. The holder is made of a pierceable material which releasably secures hoods and lures

None of the prior art have specifically addressed the problem of securing treble hooks used in ice fishing on a tip-up. There is a long felt need for a device and mechanism which can easily secure a three-prong hook used on a tip-up.

It is an object of the invention to provide a system which enables the secure attachment of a treble hook with a tip-up for safe and easy movement and storage.

It is another object of the present invention to provide a system for seeking a three-prong hook.

It is a further object of the invention to provide a system which secured a three-prong hook.

These and other objects of the invention will be described in the following summary and detailed description.

### SUMMARY OF THE INVENTION

The invention in comprises, in a preferred embodiment, four major components. First, the invention includes base comprising a dual U-shaped bracket. Second the invention includes a treble hook holder or slide. Third, the invention includes slide pins or rods on which the holder slides. Finally, the invention includes a pair of biasing springs. These are assembled together to make one unit. When assembled and installed on the tip-up, the treble hood is placed in the hook holder and drawn against the spring tension, and then locked in place with the reel and flag.

In accordance with present invention, a mechanism for supporting a treble hook on a tip up comprising a base member to affix mechanism to a tip up; at least two side supports affixed to opposite ends of the base member and supporting a rod member; a support member in slidable relation to rod member and configured to support a treble hook in a locked; spring means for biasing the support member in a first position such that when the reel and line is locked, the treble hook is locked and secured by the support member.

In a further embodiment, the invention is a mechanism for supporting a treble hook on a tip up comprising a base member for affixing the mechanism to a tip-up supporting a rod and reel; at least two u-shaped side supports affixed to opposite ends of the base member, said u-shaped side supports having axially aligned holes to hold and support a rod member; a support member having two apertures for aligning with and sliding on the rods and configured to support a treble hook in a locked position and; means for biasing the support member in a first position such that when the reel and line is locked, the treble hook is locked and secured.

In still a further embodiment, the invention is a mechanism for supporting a treble hook on a tip up comprising: a base member for affixing the mechanism to a tip-up supporting a rod and reel; at least two u-shaped side supports affixed to opposite ends of the base member, said side supports having axially aligned holes to hold and support two rod members; support member and having two apertures for aligning with and sliding on the rods and having recessed walls configured to secure and support a treble hook in a locked position; spring means affixed to the rods for biasing the support member in a first position such that when the reel and line is locked, the treble hook is locked and secured.

### BRIEF DESCRIPTION OF THE FIGURES

FIG. 1 is a perspective view of the tip up of the present invention.

FIG. 2 is an overhead view of the tip up of the present invention.

FIG. 3 is a front end view of the tip up of the present invention.

FIG. 4 is an elevation view of the present invention.

### BRIEF DESCRIPTION OF THE INVENTION

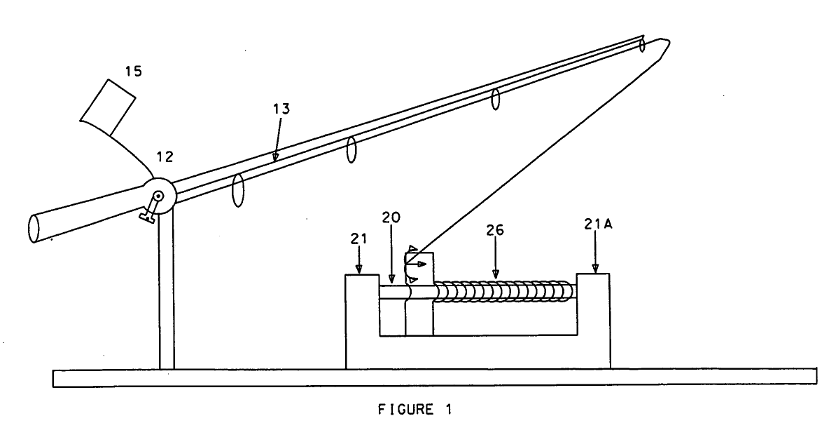

The present invention is most specifically described with reference to the enclosed Figures wherein the same numbers In a broad embodiment, the invention is designed to secure a treble hook. Referring to FIG. 1, the invention includes and is designed to work in a association with a tip-up mechanism 12. The tip up 12 holds and supports a rod and reel 13 in an upward position proximate to an ice fishing hole. The tip up is typically used with a flag 15 which is spring loaded and which pops up when the user lands a fish.

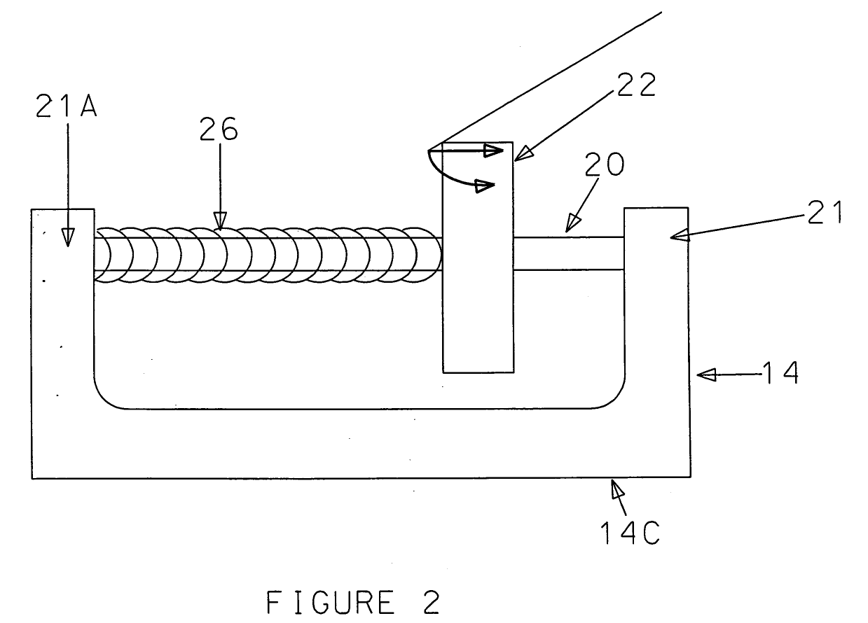

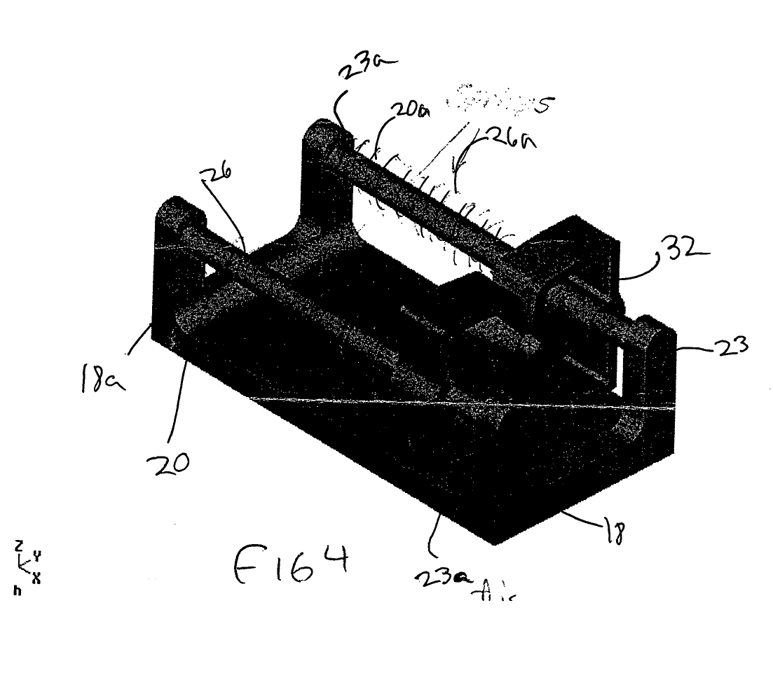

As shown in FIGS. 2 to 4, the support of the present invention comprises a base 14 having a flat bottom surface 14c. The base 14 has holes 16 which permit the base to be secured to the tip up to the base of the tip. The base 14 has attached thereto to end members 18, 18a which support rods 20, 20a. The end members form two U-shaped brackets 21, 21a. The U-shaped brackets 21a on opposite sides are axially aligned and contain two axial apertures 23, 23a.

The apertures 21, 21a support the 20, 20a rods. A movable support member 22 having axial two holes 24, 24a aligns with the rods 20, 20a and apertures 23, 23a and is slidable longitudinally along the rods 20, 20a. Two biasing springs 26, 26a surround the rods 20, 20a and bias the support member 22 toward one of the brackets 21, 21a.

The support member 22 is now described in greater detail. The support member 22 has two top half surfaces 28 divided by a crevice 30. The support member 22 is recessed 32. In operation a treble hook 32 is placed on the system so as to biased by the springs 26, 26a.

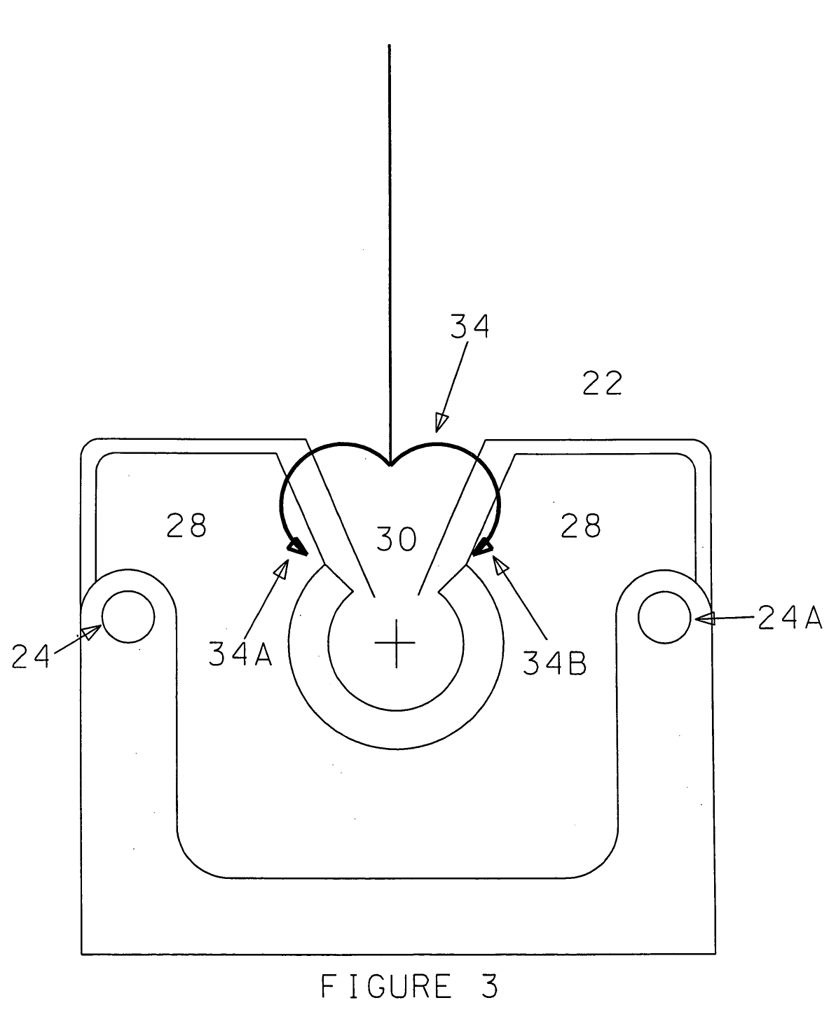

In operation, two of the hooks 34a, 34b of the treble hook 34 is secured by each of the recessed member halves as shown in FIG. 3. The third hook is extended back over the crevice 30. When the line and treble hook is locked in place by the rod and the flag, the hook is biased in a locked position by the support member 22 and the springs. In this manner, the rod, reel, treble hook and tip up mechanism can be easily moved, repositioned and stored safely and with our injury. When the treble hook is to be removed, the biased support 22 member is pushed against the spring so that the tension is released. The mechanism of the present invention can be constructed from a wide variety of woods, metal and plastics.

The present invention has been described with reference to the above discussed detailed description. It is to be appreciated that the true nature and scope of the present invention is to be determined with reference to the claims appended hereto.

1. A mechanism for supporting a treble hook on a tip up prising
a base member to affix mechanism to a tip up;
at least two side supports affixed to opposite ends of the base member and supporting a rod member;
a support member in slidable relation to the rod member and configured to support a treble hook in a locked;
spring means for biasing the support member in a first position such that when the reel and line is locked, the treble hook is locked and secured by the support member.

2. A mechanism for supporting a treble hook on a tip up comprising
a base member for affixing the mechanism to a tip-up supporting a rod and reel;
at least two u-shaped side supports affixed to opposite ends of the base member, said u-shaped side supports having axially aligned holes to hold and support a rod member;
a support member having two apertures for aligning with and sliding on the rods and configured to support a treble hook in a locked position and;
means for biasing the support member in a first position such that when the reel and line is locked, the treble hook is locked and secured.

3. A mechanism for supporting a treble hook on a tip up comprising:
a base member for affixing the mechanism to a tip-up supporting a rod and reel;
at least two u-shaped side supports affixed to opposite ends of the base member, said side supports having axially aligned holes to hold and support two rod members;
support member and having two apertures for aligning with and sliding on the rods and having recessed walls configured to secure and support a treble hook in a locked position;
spring means affixed to the rods for biasing the support member in a first position such that when the reel and line is locked, the treble hook is locked and secured.
